(19) United States
(12) Patent Application Publication
(10) Pub. No.: US 2022/0041054 A1
(43) Pub. Date: Feb. 10, 2022

(54) BEARING ASSEMBLY FOR A DRIVESHAFT

(71) Applicant: TIRSAN KARDAN SANAYI VE TICARET A.S., Manisa (TR)

(72) Inventor: Sebahattin Davazli, Manisa (TR)

(21) Appl. No.: 17/276,337

(22) PCT Filed: Jun. 22, 2019
(86) PCT No.: PCT/TR2019/050487

§ 371 Date: Mar. 15, 2021

(30) Foreign Application Priority Data
Sep. 21, 2018 (TR) 2018/13604

(51) Int. Cl. B60K 17/24; F16C 27/06

(52) U.S. Cl. CPC B60K 17/24; F16C 27/066

(57) ABSTRACT

The present invention relates to a bearing assembly (10) for a drives haft system comprising a frame (12) surrounding an opening (16); a flexible vibration isolator (20) disposed in the opening (16) and a ball bearing (50) is mounted at a central opening (24) of the vibration isolator (20). The ball bearing assembly (10) comprises a spherical cup (40) is nested to a central opening (24) of the vibration isolator (20) and spherically pivoted such that in an adjustment position changing the rotational axis (x) of the ball bearing (50) by a deviation angle (a) when a rotational force is applied.

### TECHNICAL FIELD

The present invention relates to a mounting element for a driveshaft system comprising a front shaft, a two-part or a multi-part shaft, in particular a bearing assembly with bearing cushion.

### PRIOR ART

The flexible mounting elements of the shafts of the vehicles, in particular driveshafts, have bearing assemblies comprising a bellows mounting member disposed in a central axis in a U-like frame, for example the vibration isolators and a bearing that is secured in the middle of the front shaft. The bearing assembly is securely mounted on the lower part of the vehicle. The driveshaft is swivel jointed by a bearing inside the bearing assembly. During the installation, the driveshaft extension axis must be changed due to the incorrect or improper position of the bearing assembly for various reasons. Failure to change the axis will cause strain on the bellows mounting element, which helps damp the vibrations.

U.S. Pat. No. 5,172,985A patent publication discloses a driveshaft assembly that can be adjusted automatically while still providing adequate vibration isolation in case of misalignment of the driveshaft. The anchoring flange and rear die-stamped plate are solidly interconnected to one another by means of side blocks which are provided with threaded holes so that this assembly may be secured under a bent sheet-metal bracket whose lateral rims are provided with slots and holes for attaching and adjusting the bearing.

EP0160212 discloses a suitable mounting assembly for mounting the driveshaft on a vehicle body. The outer element is secured to the vehicle body by a U-shaped link and the inner member receives the ball race of the split shaft. Each limb of the link is pivotally connected at one end to the vehicle body by respective pivot means including a mounting bracket for attachment to the vehicle body and at the other free end to the outer member by respective pivot means received in the locating holes defined by the flanges. Each pivot means comprises a rubber bush pivot and the torsional stiffness of the pivot may be varied by altering the characteristics of the bush.

### BRIEF DESCRIPTION OF THE INVENTION

The object of the invention is to extend the effective service life of the axially adjustable bearing cushion for the driveshaft system.

To achieve the aforementioned objective, invention comprises a bearing assembly comprising a frame surrounding an opening; a flexible vibration isolator disposed in the opening and a ball bearing is mounted at a central opening of the vibration isolator. The bearing assembly comprising a spherical cup is nested to a central opening of the vibration isolator and spherically pivoted such that in an adjustment position changing the rotational axis of the ball bearing by a deviation angle when a rotational force is applied. The bearing assembly comprises a spherical cup having a central opening engaging to a vibration isolator and is rotating by applying a rotation force in an adjustment position, wherein the bearing is spherically pivoted to change the rotational axis by a deviation angle.

A preferred embodiment of the invention comprises a ring element having a corresponding curved wall which directly engages the central opening of the vibration isolator from the radial outer part and the spherical cup is disposed to the radial inner part from the outer periphery. The ring element facilitates interlocking of the spherical cup with the vibration isolator. This allows the bearing assembly to be easily rotated in the adjustment position while maintaining its compact structure. The ring element is preferably flat and metal annular form. In an alternative embodiment it may be formed from more than one ring or a structure made of different cross-sectional profile or a composite polymer.

In a preferred embodiment of the invention, the curved wall of the ring element is having a circumferential concave form of substantially the same diameter as the outer periphery of the spherical cup. Thus, a spherical cup with e.g., a suitable coefficient of friction can be rotated end-to-end with an additional force in the ring element.

In a preferred embodiment of the invention, the length of the outer periphery of the spherical cup is substantially equal to the length of the curved wall in a transverse direction. In coaxial position, the spherical cup is fully aligned with the ring element to form a compact structure. Alternatively, it is possible to form a protruding form from the ring element from the spherical cup by when it is longer or to indent inside the ring element from the spherical cup when it is shorter.

In a preferred embodiment of the invention, two opposing inner openings of the ring element is in the form of a hollow truncated sphere with which directly fit into the central opening. The truncated spherical form allows the spherical cup to be easily engaged within the concave form of the rotational surface by keeping the planar portions inclined.

In a preferred embodiment of the invention, the opening, central opening and the bearing is coaxially aligned in the rotational axis. Thus, a structure that effectively damps the vibration generated during rotation and operates under silent and stable dynamic loads is obtained.

In a preferred embodiment of the invention, the vibration isolator comprises substantially rubber material. The rubber material extends the service life of the bearing assembly due to its vibration damping and long service life.

In a preferred embodiment of the invention, the rotating force of the spherical cup in the adjustment position is set to at least 1 N. This prevents the spherical cup from rotating spontaneously or in vibrations by providing a self-locking feature.

In a preferred embodiment of the invention, the bearing assembly comprises a radially outwardly extending extension portion from each other from the top. The extension portions allow easy mounting the bearing assembly to the vehicle chassis.

A preferred embodiment of the invention comprises a driveshaft system comprising a bearing assembly according to any one of the preceding claims.

A preferred embodiment of the invention comprises the steps of comprising the steps of aligning the front shaft and the rear shaft mounted on the bearing assembly with a midship joint therebetween, on the rotational axis; securing the bearing assembly with the rotational axis at the deviation angle and aligning the front shaft and/or the rear shaft in the bearing assembly by rotating the spherical cup to the deviation axis in the adjustment position.

### BRIEF DESCRIPTION OF THE FIGURES

FIG. 1, is a front view of a representative embodiment of a composite driveshaft ready for installation in the vehicle.

FIG. 2, is a front installation view of a representative embodiment of the bearing assembly according to the invention used in a driveshaft.

FIG. 3 is a cross-sectional representation of the driveshaft shown in FIG. 2 with a spherical cup on a deviation axis in an adjustment position.

### DETAILED DESCRIPTION OF THE INVENTION

In this detailed description, the subject matter has been described with reference for examples, such that there is no restriction and only to better describe the subject matter.

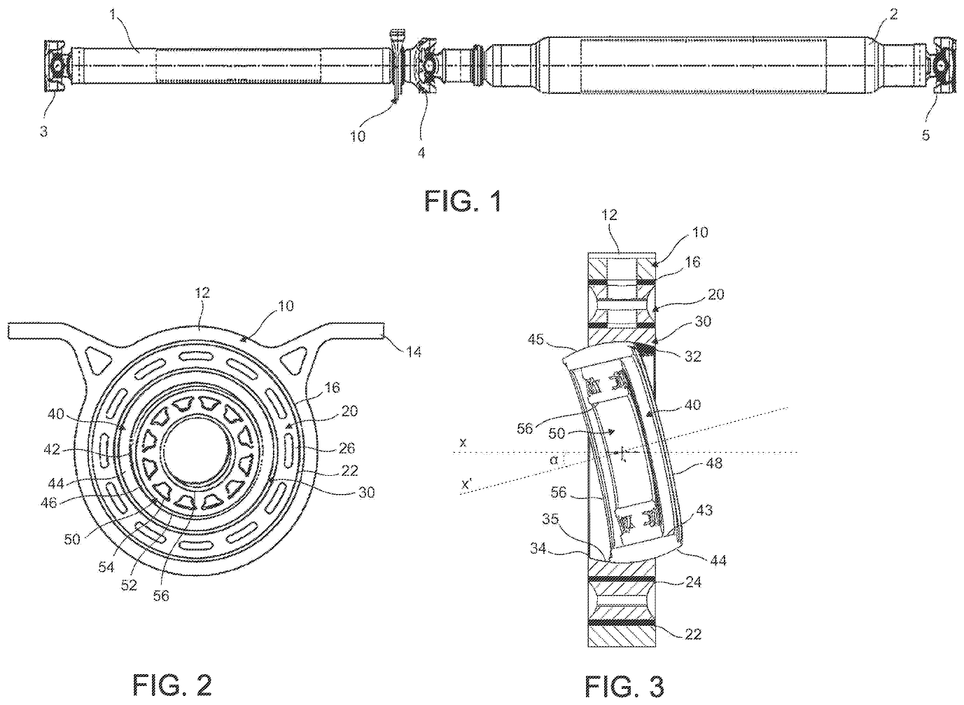

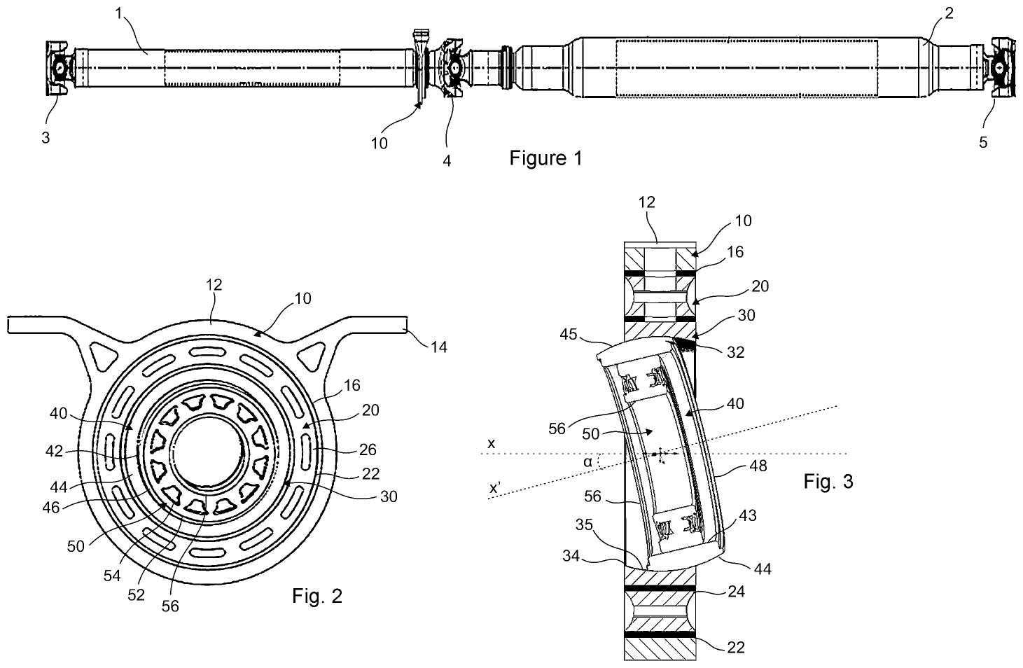

FIG. 1 is a front view of a two-part driveshaft comprising a representative embodiment of the inventive bearing assembly. A front shaft (1) and a rear shaft (2) extend along the same rotational axis (x). The front shaft (1) has a front joint (3) at its free end. On the other hand, at the opposite free end, the rear shaft (2) carries a rear joint (5). The front and rear shaft (1,2) are rotationally connected to each other by an midship joint (4) from the facing portion. A bearing assembly (10) attaches the front shaft (1) from its central center to a vehicle chassis (not shown) so as to coincide with the rotational axis (x).

The bearing assembly (10) shown from the front in FIG. 2 comprises a hollow short cylindrical frame (12). On the frame (12), an extension portion (14) is arranged in the atrium structure which faces radially outward in both directions. The extension portion (14) is integrated to the frame (12). A hollow cylindrical vibration isolator (20) made of rubber material is seated in a circular opening (16) defined by the frame (12) and passing through the center of the rotational axis (x). The outer walls (22) of the vibration isolator (20) are cylindrical and fit directly into the opening (16). Above the vibration isolators (20) are channels (26) in the form of holes which are evenly spaced from one another in the transverse direction. The channels (26) improve the vibration isolation properties of the vibration isolators (20). At the center of the vibration isolators (20) is a circular central opening (24). The central opening (24) is centered in the circle, co-axial in the rotational axis (x).

A ring element (30) is inserted directly into the central hole (24) through the outer walls. The ring element (30) is made of metal material. In FIG. 3, the bearing assembly (10) is shown in lateral section. The inner part of the ring element (30) comprises a curved wall (35) in a concave form. A front part (32) and a rear part (34) forming the face surfaces of the ring element (30) are planar. A spherical cup (40) made of composite material is mounted to the curved wall (35) by means of forming a spherical joint having rotational freedom. The lateral length of the spherical cup (40) in the direction of the rotational axis (x) is equal to the lateral length of the ring element (30). The spherical cup (40) has a large central bushing (43). The diameter of the central bushing (43) is substantially equal to the diameter of the outer race (52) of a ball bearing (50) to be mounted therein. The central bushing (43) has a cylindrical hole structure of diameter along its length. A cylindrical ball bearing (50) is driven from the outer race (52) into the central bushing (43). The front shaft (1) passes through an inner race (56) coaxial with the outer race (52) of the ball bearing (50). The outer periphery (42) of the spherical cup (40) is movable on the curved wall (35). Thus, the spherical cup (40) is rotated to a deviation angle (a) after mounting of the front shaft (1) and extended in a deviation axis (x′).

Under auspices of spherical joint formed by the spherical cup (40), it is possible that the deviation axis (x′) has vertical or horizontal angular components relative to the rotational axis (x). That is, the spherical cup (40) can be aligned to compensate axial deviations occurring in two axes.

In FIG. 3, cross-sectional view of ball bearing (50) adapted to a deviation axis (x′) by rotating up to a deviation angle (a) of the spherical cup (40) by an operator. The spherical cup (40) is disposed in a lateral inclined position in a rear part (32) of the ring element (30) that faces the rear shaft and a front part (34) that faces the front shaft (1) forming a gap towards the edge. At this time, the operator exerted a force of about 1 N due to the friction between the spherical cup (40) made of composite material and the curved wall (35) in an adjustment position. The spherical cup (40) then retains its position in the adjustment position again in the working position by means of friction. In this position, the outer periphery of the spherical cup (40) protrudes from the lower part (44) to the rear part (32) and from the upper part (45) to the front part (34). After the adjustment position, the frame (12) opening and the vibration isolator's (20) central opening (24) maintain their coaxial co-axial structure with the ring element (30) on the rotational axis (x), but the spherical cup (40) and the central bushing (43) and the ball bearing (50) is coaxially and co-axially secured in the deviation axis (x′).

REFERENCE NUMBERS

1 Front shaft
2 Rear shaft
3 Front joint
4 Midship joint
5 Rear joint
10 Bearing assembly
12 Frame
14 Extension portion
16 Opening
20 Vibration isolator
22 Outer wall
24 Central opening
26 Recess
30 Ring element
32 Rear part
34 Front part
35 Curved wall (dönme yüzeyi)
40 Spherical cup
42 Outer periphery
43 Central bushing
44 Lower part
45 Upper part
46 Inner opening
48 Rear opening
50 Ball bearing
52 Outer race
56 Inner race
x Rotational axis
x′ Deviation axis

1. A bearing assembly for a driveshaft system comprising a frame surrounding an opening; a flexible vibration isolator disposed in the opening and a ball bearing is mounted at a central opening of the vibration isolator characterized in that a spherical cup is nested to a central opening of the vibration isolator and spherically pivoted such that in an adjustment position changing the rotational axis of the ball bearing by a deviation angle when a rotational force is applied.

2. The bearing assembly according to claim 1, wherein a ring element is having a corresponding curved wall which directly engages the central opening of the vibration isolator from the radial outer part and the spherical cup is disposed to the radial inner part from the outer periphery.

3. The bearing assembly according to claim 2, wherein the curved wall of the ring element is having a circumferential concave form of substantially the same diameter as the outer periphery of the spherical cup.

4. The bearing assembly according to claim 2, wherein the length of the outer periphery of the spherical cup is substantially equal to the length of the curved wall in transverse direction.

5. The bearing assembly according to claim 2, wherein two opposing inner openings of the ring element is in the form of a hollow truncated sphere with which directly fit into the central opening.

6. The bearing assembly according to claim 1, wherein the opening, central opening and the ball bearing is coaxially aligned in the rotational axis.

7. The bearing assembly according to claim 1, wherein the vibration isolator comprises substantially rubber material.

8. The bearing assembly according to claim 1, wherein the rotating force of the spherical cup in the adjustment position is set to at least 1 N.

9. The bearing assembly according to claim 1, wherein the bearing assembly comprises a radially outwardly extending extension portion from each other from the top.

10. A driveshaft comprising a bearing assembly according to claim 1.

11. A production method to manufacture a driveshaft according to claim 10, comprising:
aligning the front shaft and the rear shaft mounted on the bearing assembly with a midship joint therebetween, on the rotational axis;
securing the bearing assembly with the rotational axis at the deviation angle; and
aligning the front shaft and/or the rear shaft in the bearing assembly by rotating the spherical cup to the deviation axis in the adjustment position.
